(19) United States
(12) Patent Application Publication
(10) Pub. No.: US 2015/0098577 A1
(43) Pub. Date: Apr. 9, 2015

(54) SYSTEMS AND METHODS FOR IDENTIFYING NOISES

(71) Applicant: JS Products, Inc., Las Vegas, NV (US)

(72) Inventors: James Moore, Las Vegas, NV (US); Javier Hernandez, Las Vegas, NV (US); Kevin Jones, Las Vegas, NV (US)

(21) Appl. No.: 14/506,514

(22) Filed: Oct. 3, 2014

Related U.S. Application Data
(60) Provisional application No. 61/887,289, filed on Oct. 4, 2013.
(60) Provisional application No. 62/002,756, filed on May 23, 2014.

(51) Int. Cl. H04R 29/00

(52) U.S. Cl. CPC H04R 29/00
USPC 381/58

(57) ABSTRACT

An audio controller is provided which includes an audio transducer interface that is capable of receiving audio signals from one or more audio transducers each associated with a channel. A channel selector is configured to selectively connect the audio signals to an output of the audio controller. A tone detector receives a tone from a mobile device and the tone is associated with a selected channel or indicating a channel change. The tone causes the channel selector to output audio associated with a channel. A listening device interface transmits the audio output from the channel selector to a listening device. The audio signal is presented to a mobile device, such as a smartphone or table device. Audio signal received by mobile device may be displayed in graphical form, recorded, or processed and one or more modification may be made to the audio signal such as equalization or an offset.

### 1. PRIORITY CLAIM

This application claims priority to U.S. Provisional Patent Application No. 61/887,289 entitled Systems and Methods for Identifying Noises which was filed on Oct. 4, 2013 and U.S. Provisional Patent Application No. 62/002,756 entitled Systems and Methods for Identifying Noises which was filed on May 23, 2014.

### 2. FIELD OF INVENTION

The field of the invention relates generally to systems and methods for identifying noises, and more particularly, to systems and methods including a mobile device used to facilitate identifying unwanted noises, especially on vehicles.

### 3. BACKGROUND

Moving parts sometimes generate undesired noises. In addition to possibly being an annoyance to the people nearby, the noise may indicate a problem with a moving parts. This is especially true in ground-based vehicles like cars, where noises may emanate from moving parts, like axels and joints, as well as loose or damaged parts. Numerous other devices having moving parts also suffer from unwanted vibration and noise generation.

In many instances the vibration and resulting audible sounds are a sign of a lose part, an imbalance, or other unwanted abnormality. For example, most mechanical items, when new or adjusted properly do not make noise, rattle, squeak or otherwise vibrate. By detecting and correcting the vibration or noise, the operational life the mechanical system is extended.

However, it can be difficult to locate the source of the noise or vibration. For example, in the case of an automobile, traveling along a road can trigger the unwanted noise in a car but because of engine and road noise, the unwanted noise may be difficult to hear. The unwanted noise may also be intermittent and/or at a frequency that makes identifying the source difficult. Commonly, drivers might bring their car to a mechanic to diagnose the unwanted noise. To diagnose the problem, the mechanic may either drive the vehicle in an attempt to reproduce the noise or may rely on the often inaccurate description of the noise from the driver.

Even if the driver or mechanic is able to hear the noise when inside the cabin of the automobile, it is even more difficult to determine, with any precision, where the noise originates. The noise could be in the engine compartment or trunk, or from any number of automobile components. Several prior art system have been proposed to locate the noise, but the prior art devices suffer from several drawbacks caused by the limitations of the technology at the time of development of the prior art solutions. The prior art systems provided limited functionality and poor audio quality. In addition, prior art solutions required dedicated complex hardware that limited access to vibration diagnostic equipment.

Accordingly, there is a need for systems and methods for identifying noises, especially unwanted noises in vehicles.

### SUMMARY

In one embodiment, an audio controller is provided. The audio controller includes an audio transducer interface that is capable of receiving multi-channel audio from one or more audio transducers and each of the audio transducers is associated with a channel. A channel selector is configured to receive the multi-channel audio from the audio transducer interface. A tone detector is configured to receive a tone from a mobile device (the tone being associated with a selected channel) and to cause the channel selector to output audio associated with the selected channel. A listening device interface is configured to transmit the audio output from the channel selector to a listening device.

In another embodiment, a system is provided that comprises one or more audio transducers and an audio controller. The audio controller includes an audio transducer interface that is capable of receiving multi-channel audio from one or more audio transducers and each of the audio transducers is associated with a channel. A channel selector is configured to receive the multi-channel audio from the audio transducer interface. A tone detector is configured to receive a tone from a mobile device (the tone being associated with a selected channel) and to cause the channel selector to output audio associated with the selected channel. A listening device interface is configured to transmit the audio output from the channel selector to a listening device.

In yet another embodiment, a method for changing channels using an audio controller is provided. The method includes receiving audio from one or more channels and receiving a tone from a mobile device. The tone is associated with a selected channel. The method further includes identifying the selected channel from the one or more channels based on the tone and transmitting audio from the selected channel.

In yet another embodiment, a method for changing channels on an audio controller is provided. The method includes receiving a user input associated with a selected channel. A tone is transmitted to the audio controller. The tone is associated with the selected channel. The method further includes receiving audio from the selected channel via the audio controller and processing the received audio.

In one embodiment, an audio controller is provided which includes an audio transducer interface that is capable of receiving multi-channel audio from one or more audio transducers such that each of the one or more audio transducers are associated with a channel. A channel selector is provided that is configured to receive the multi-channel audio from the audio transducer interface. A tone detector is configured to receive a tone from a mobile device such that the tone is associated with a selected channel. The tone detector is configured to cause the channel selector to output audio associated with the selected channel. A listening device interface is also provided that is configured to transmit the audio output from the channel selector to a listening device.

In one embodiment the audio controller comprises a processor configured to receive an indication of the selected channel from the tone detector and to cause the channel selector to output audio associated with the selected channel. The audio controller may further comprise a wireless interface configured to wirelessly transmit the audio output. In one configuration the audio controller further comprises a mobile device interface configured to transmit the audio output from the channel selector to the mobile device. The audio controller may further comprise a pre-amplifier configured to amplify the multi-channel audio from the audio transducer interface and to output the amplified multi-channel audio to the channel selector.

Also disclosed is a system that includes one or more audio transducers and an audio controller. The audio controller may include an audio transducer interface that is capable of receiving audio signals from one or more audio transducers such that each of the one or more audio transducers is associated with a channel. A tone detector is configured to receive a tone from a mobile device. The tone indicates a change in a selected channel to thereby change the selected audio signal. The tone detector is configured to transmit a channel change signal. Also part of this embodiment is a channel selector coupled to the audio transducer interface, the channel selector configured to receive the channel change signal, and in response, cause the channel selector to change which audio signal is the selected audio signal. The selected audio signal is sent to the mobile device. A listening device interface is also provided and configured to transmit the selected audio signal from the channel selector to a listening device.

In one embodiment, the audio controller further comprises a mobile device interface configured to transmit the audio output from the channel selector to the mobile device. The tone may be received from the mobile device over the mobile device interface based on user input which generates the tone. The mobile device may include a memory storing non-transient machine readable code configured as an audio recorder configured to record audio received from the audio controller. In one configuration, the mobile device further comprises an audio processor configured to process audio received from the audio controller such that processing audio comprises at least one of equalization, offset, and audio signal comparing to an audio signal library. The mobile device may include a memory storing non-transient machine readable code configured to transmit recorded audio to a remote location. The non-transient machine readable code may be configured to receive and display a diagnosis from the remote location.

Also presented is a method for changing channels using an audio controller that may comprise receiving audio from two or more channels and receiving a tone from a mobile device such that the tone is associated with a selected channel or indicating a channel change request. The method also identifies the selected channel from the two or more channels based on the tone and transmits audio from the selected channel or from a new channel to a user. In one embodiment, transmitting audio from the selected channel comprises transmitting the audio to the mobile device and to an audio interface for receipt by a user. This method may perform a switching operation in response to the channel change request.

Also disclosed is a method for changing channels on an audio controller. This method may include receiving audio signals from two or more channels where the audio signals are received from transducers connected to two or more locations of a machine. This method of operation then receives a user input at the audio controller to change and establish a selected channel, and performs a switching operation within the audio controller to electrically connect the selected channel to an output of the audio controller. Next, the method transmits the audio signal from the selected channel to the user and sends the audio signal from the selected channel to a mobile device. The mobile device may be configured to display one or more aspects of the audio signal.

Sending the audio signal may include sending the audio signal to a user either through a wired or wireless link. The received audio may be stored. Sending the audio signal from the selected channel to a mobile device may include sending the audio signal to an audio input port of the mobile device. In one embodiment, frequency equalization or magnitude offset to the audio signal may occur. The method may further comprise displaying a waveform of the audio signal from the selected channel on the mobile device.

### BRIEF DESCRIPTION OF THE DRAWINGS

FIG. 1 is a block diagram of an exemplary system for identifying noises.

FIGS. 2A and 2B illustrate an exemplary audio controller for use with a tablet and the system of FIG. 1.

FIG. 2C is an alternative embodiment of the audio controller with certain functionality embodied in mobile device and associated software.

FIGS. 3A and 3B illustrate an exemplary audio controller for use with a smart phone and the system of FIG. 1.

FIG. 4A illustrates exemplary audio transducers for use with a first type audio controller.

FIG. 4B illustrates exemplary audio transducers 400 for use with a second type audio controller.

FIG. 4C illustrates exemplary light version of the audio detector paired directly to a mobile device through a splitter element.

FIG. 5 is a block diagram of an exemplary mobile control system for use with the system of FIG. 1.

FIG. 6 is a flowchart of an exemplary method for use with the system of FIG. 1.

FIG. 7 is a flowchart of an exemplary method for use with the system of FIG. 1.

FIG. 8 is a screen shot of an exemplary graphical user interface for use with the mobile control system of FIG. 5.

FIGS. 9A and 9B illustrate an exemplary flow diagram of an example method of operation.

FIG. 10 is an exemplary screen shot of a channel identification screen presented by the software.

FIG. 11 is an example screen display presented by the software for displaying information regarding the audio signal to the user.

FIG. 12 is an example screen display for controlling offset and refresh rate.

FIG. 13 illustrates an exemplary screen shot of a tone generated by the mobile device to cause the audio controller to change the channel.

FIG. 14 illustrates an example screen display showing file listings with an option to e-mail audio file.

### DETAILED DESCRIPTION

The systems and methods described herein facilitate the analysis of audio signals associated with a subject. The subject may be a vehicle such as a car, a rotatable device such as a turbine, or any other system or device with moving or movable components. Vibrations in the subject may cause, or itself be, audible noises that may indicate loose or misaligned components or other issues. In many cases, the noise is an annoyance. The subject matter described herein enables a user to identify the source of such noises by analyzing and comparing one or more audio sources.

The operating environment for the subject matter commonly includes a vehicle that has been brought to a technician in order to identify and eliminate a sound heard by a driver of the vehicle. The technician uses a device as described herein to analyze audio collected from various parts of the vehicle. More particularly, the technician may use the device to listen to the sounds collected at several locations on the vehicle. Without being limited to any particular method or theory of operation, by collecting sounds from various locations, the technician can hone in on the source of the sound for further diagnosis. By isolating and comparing the various audio sources, the systems and methods described herein boost the technician's ability to identify the source of sounds while using commodity mobile devices to aid in the process.

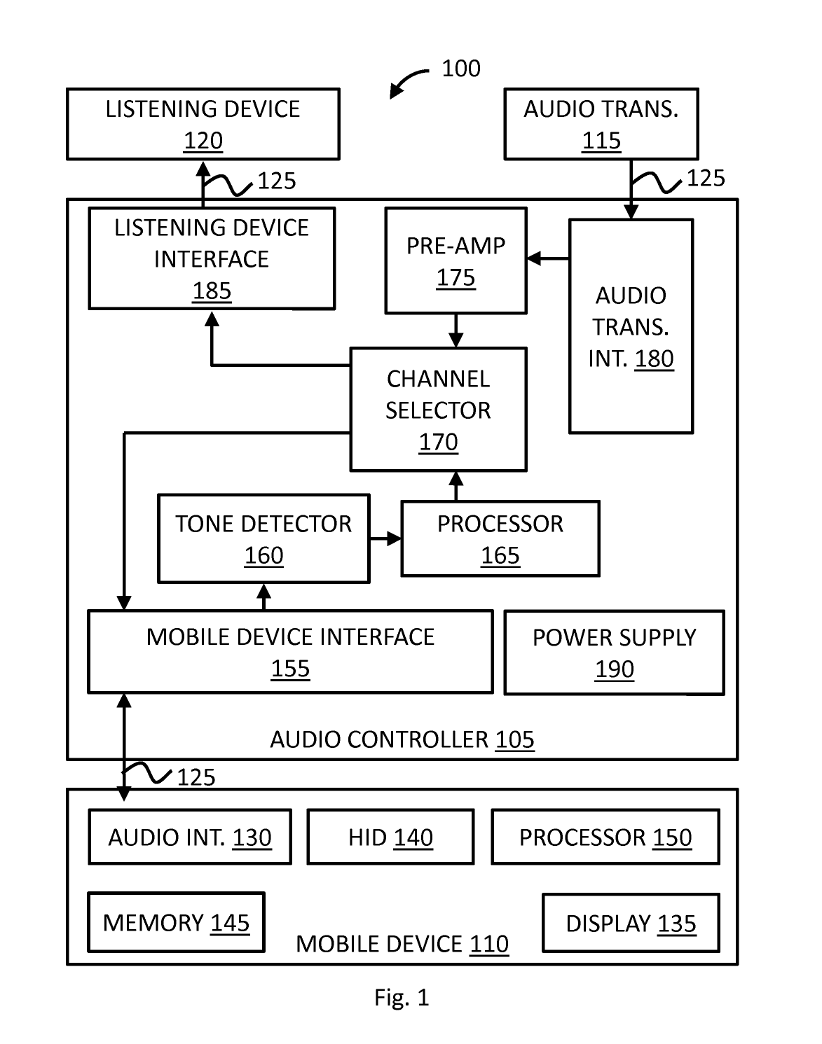

FIG. 1 is a block diagram of an exemplary system 100 for identifying unwanted sounds. The system 100 includes an audio controller 105, a mobile device 110, one or more audio transducers 115, and a listening device 120. In the exemplary embodiment, the audio controller 105 serves as a hub for the audio transducers 115, the listening device 120, and the mobile device 110 connected to it. Data or other signals may be transmitted through and/or routed by the audio controller 105. Alternatively, or additionally, two or more components of the system 100 may be communicatively coupled directly without the audio controller 105 intervening. For example, the listening device 120 may be directly coupled with the mobile device 110.

Additional components, not shown in FIG. 1, may be present in the system 100. Some of the components shown in FIG. 1 may not be present in all embodiments of the system 100, and some components may be combined together. For example, the mobile device 110 may not be present in embodiments where the audio controller 105 includes functionality similar to the mobile device 110. In another example, the listening device 120 may not be present if the mobile device 110 is configured as a listening device.

The components of the system 100 may be communicatively coupled using one or more communication links 125. The communication links 125 may be point-to-point or configured in any topology and may be uni- or bi-directional. The communication links 125 may be distinct and heterogeneous. In other words, each of the communication links 125 may use a different communication medium. The communication links 125 may be wired or wireless, including communications by wires, fiber optics, infrared, radio waves, etc. Wireless variations may include use of Bluetooth, Wi-Fi, and other radio frequency-based communications. Bluetooth is a registered trademark of Bluetooth SIG, Inc., and Wi-Fi is a registered trademark of the Wi-Fi Alliance. For example, the communication link 125 between the audio transducers 115 and the audio controller 105 may be long wires that enable the audio transducers 115 to be placed in various locations on a vehicle while the audio controller 105 remains inside the vehicle.

The mobile device 110 may be a smart phone, tablet, portable computer, or any other kind of computing device that includes a processor and an ability to execute software code, such as machine readable or machine executable instructions. In the exemplary embodiment, the mobile device 110 includes an audio interface 130, a display 135, at least one human interface device (HID) 140, a memory 145, and at least one processor 150. The audio interface 130 may include a combined input and output port, such as a 3.5 mm connector. The display 135 and at least one input device 140 may be combined as a touch screen device.

The audio transducers 115 may be any sensor that converts vibrations, whether sound waves, mechanical vibrations, or otherwise, into electrical signals. The audio transducers 115 may be distinct and heterogeneous, meaning that not all transducers are necessarily the same. For example, one audio transducer 115 may be a microphone while another audio transducer 115 is an accelerometer.

The listening device 120 includes at least one speaker for transmitting sounds from the system 100. The listening device 120 may be headphones or a car radio, among other things. The listening device 120 may transmit sounds collected by the audio transducers 115 in real-time and/or may transmit such sounds as recorded by the system 100 and/or as modified by the system 100. For example, the mobile device 110 may record and play back sounds from the audio transducers 115 and may filter or otherwise modify the sounds. Filtering may be helpful in isolating the vibration from road noise or other known noises.

In the exemplary embodiment, the audio controller 105 includes a mobile device interface 155, a tone detector 160, a processor 165, a channel selector 170, a pre-amplifier 175, an audio transducer interface 180, a listening device interface 185, and a power supply 190. The various components of the audio controller 105 may be communicatively coupled as shown in FIG. 1 or otherwise. Various buses (shown, but not numbered) connect the components and may be digital or analog. Additional buses not shown may provide power from the power supply 185 to the various components. The power supply 190 may include a battery (not shown) and/or a power input (not shown), either or both of which may power the audio controller 105. The power input may charge the battery.

The mobile device interface 155 is configured to communicatively couple with the mobile device 110. More particularly, the mobile device interface 155 enables audio, whether digital or analog, to pass bi-directionally between the audio controller 105 and the mobile device 110. In one embodiment, the mobile device interface 155 includes a male 3.5 mm male plug for coupling to the audio interface 130 of the mobile device 110. In another embodiment, the mobile device interface comprises a Bluetooth connection, or other wireless standard, to communication audio or data to the mobile device 110. It is also contemplated that the listening device interface 185 may comprise a wired or wireless link to communicate audio to a user or listener. For example, Bluetooth headphones may be used as the listening device 120 and are thus paired to the listening device interface 185, which may include a wireless transmitter.

In order to communicate control information from the mobile device 110 to the audio controller 105, the mobile device 110 is configured to generate audio tones that each have a pre-determined association with a control command. Thus, the audio link between the audio controller 105 and the mobile device 110 may be used to send control data. The tone detector 160 is configured to receive audio input from the mobile device 110 and determine whether and which audio tones were received from the mobile device 110.

In the exemplary embodiment, the audio tones are used to indicate which channel (i.e., which audio transducer 115) should be used by the audio controller 105. A channel may be indicated by the tone using the frequency, pulses, duration, and/or any other audio characteristic of the tone. More generally, the audio tones may be used to communicate control commands and/or other data. For example, the tones may be used to instruct a Bluetooth module to enter pairing mode or the tones may be used to communicate an ASCII string of characters to the Bluetooth module to set the broadcast name of the module.

The tone detector 160 is configured to transmit an instruction to the processor 165 based on the received audio tones. The instruction may be as simple as which channel should be selected. The processor 165 receives and carries out the instruction, sometimes after executing additional logic. In the exemplary embodiment, the processor 165 is configured to transmit a channel selection to the channel selector 170 indicative of the channel selected by the mobile device 110. For example, if there are six available channels, the channel may be indicated by a three-bit encoded instruction to the channel selector 170.

The channel selector 170 is configured to receive the channel selection from the processor 165 and selectively output an audio signal from the selected channel. In the exemplary embodiment, there are six audio transducers 115 connected to the audio controller 105 via the audio transducer interface 180. Alternatively, any number of audio transducers 115 may be used. The connection may be made by 3.5 mm connectors. In some embodiments, the connection is wireless, e.g., by RF signal, including Bluetooth. Each of the audio transducers 115 is connected to the channel selector 170 via the pre-amplifier 175, which is configured to amplify the signal from each audio transducer 115. The channel selector 170 is therefore configured to output the amplified audio from the selected audio transducer 115. The channel selector 170 may include relays, a signal decoder, and/or other components in order to operate as described herein.

The audio output by the channel selector 170 is received by the listening device interface 185 and the mobile device interface 155. From the listening device interface 185, the audio is transmitted to the listening device 120 via one of the communication links 125. In the exemplary embodiment, the listening device 120 is headphones connected to the listening device interface 185 via Bluetooth. From the mobile device interface 155, the audio is transmitted to the mobile device 110 via one of the communication links 125. In the exemplary embodiment, the audio is received by the mobile device at a microphone input, which is combined with the headphone output. Accordingly, both the listening device 120 and the mobile device 110 receive audio via the audio controller 105 from the selected audio transducer 115.

During operation, a user places one or more audio transducers 115 at desired locations of the subject (e.g., a vehicle). The transducers 115 may be clamped or otherwise affixed, usually temporarily, to or near components suspected of causing undesired noises. The transducers 115 are communicatively coupled with the audio controller 105, usually by wires terminated by 3.5 mm connectors. The mobile device 110 and the listening device 120 are also communicatively coupled with the audio controller 105. At this point, the subject is operated (i.e., is driven, in the case of a car) to induce the undesired noises.

The user selectively listens to the audio transducers 115 by indicating to the mobile device 110 which channel, or audio transducer 115, is desired. The mobile device 110 transmits a tone corresponding to the selected channel to the tone detector 160, which detects the tone and sends an instruction to the processor 165. The processor 165 causes the channel selector 170 to switch to the desired channel, resulting in audio from the desired transducer 115 being transmitted to the listening device 120. The channel selector may comprise a switch. The user may listen to each channel in turn, and compare the audio from the various transducers 115 in order to determine the source of the undesired noise. By isolating each channel, the undesired noise is more readily identified and located.

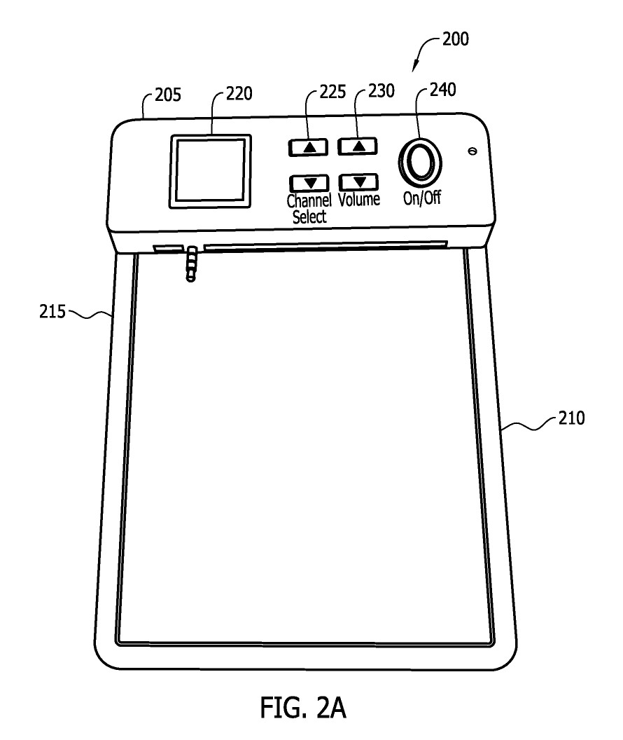

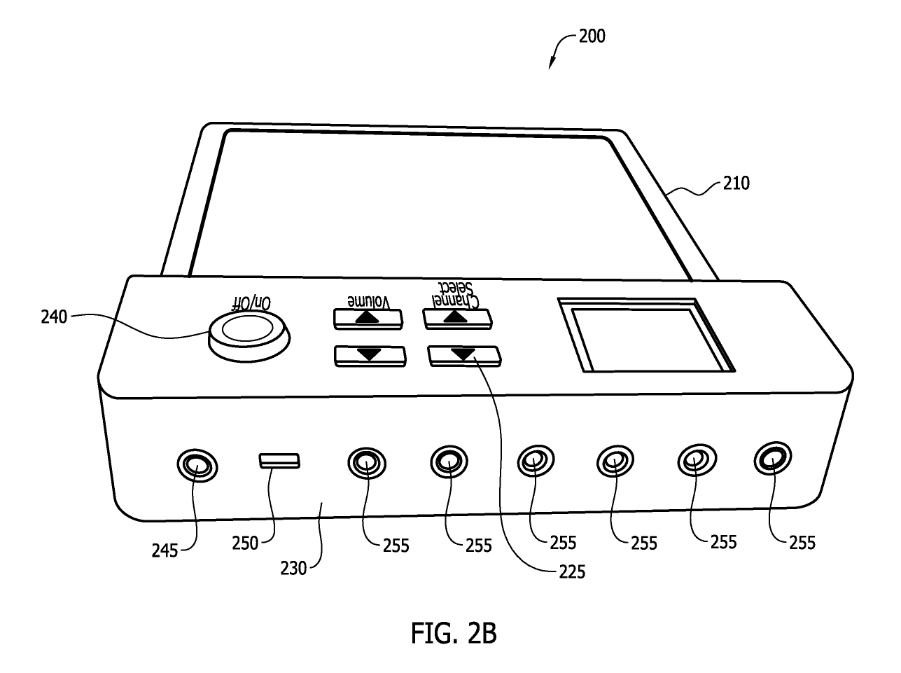

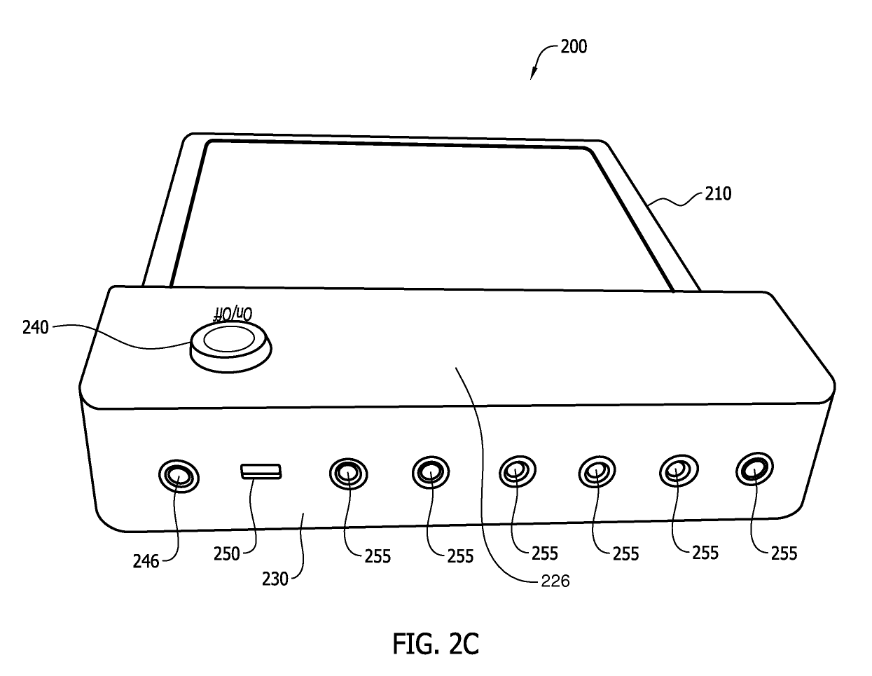

FIGS. 2A and 2B illustrate an exemplary audio controller 200 for use with a tablet. The audio controller 200 of FIGS. 2A and 2B may be similar to the audio controller 105 of FIG. 1 and similar components are labeled using the same reference characters. Although a tablet is described as the mobile device 110, other mobile devices 110, including smart phones, may be used with the audio controller 200.

The audio controller 200 includes a housing 205 and a base 210. The housing contains the electronics and other components associated with the audio controller 200. The base 210 provides support to the mobile device and facilitates alignment between the mobile device and the housing 205. More particularly, a male connector 215 provides a connection between the mobile device interface 155 (not shown) of the audio controller 200 and the audio interface 130 (not shown) of the mobile device.

In this embodiment, the housing 205 may include a display 220, channel selectors 225, volume controls 230, and a power button 240. The display 220 may display the on/off status of the audio controller 220 and/or the currently selected channel. The channel selectors 225 and the volume controls 230 may each include up and down buttons. In some embodiments, the housing 205 does not include one or more of the display 220, channel selectors 225, volume controls 230, and the power button 240. In other embodiments, the display 220, the channel selectors 225, and the volume controls may be configured as part of the mobile device such that these features are configured to be displayed on the screen through the use of machine readable code, also referred to as software, or processor executable code, which executes on a process of the mobile device. For example, the user may use one or more buttons of the mobile device, or a touch screen interface of the mobile device to display information regarding the docking station status, channel, volume, battery, or any other matter. In addition, the one or more buttons of the mobile device, or a touch screen interface of the mobile device may be used to adjust the volume, change or select channels, or any other function of the docking station or software described herein. In such an embodiment,

The housing 205 may also include a headphone jack 245 for connection with a listening device, such as the listening device 120, a charging port 250, which may be a Universal Serial Bus port, and one or more audio transducer ports 255. Each of the audio transducer ports 255, which may be 3.5 mm jacks, is associated with a channel and is coupled to the audio transducer interface 180 (not shown).

FIG. 2C is an alternative embodiment of the audio controller with certain functionality embodied in mobile device and associated software. As shown in FIG. 2C, an optional embodiment includes the volume control, channel select, and display functions as part of or handled by the mobile device, such as a smartphone or tablet. As compared to FIG. 2A, 2B, like elements are labeled with identical reference numbers and are not discussed again. In this embodiment, a button 246 is provided to reset or pair the docking station 200 to either reset any electronics in the docking station or for pairing the docking station with wireless headphone, such as a bluetooth pairing function. As such, the headphone connector port is not present in this embodiment as it can be paired with a wireless headphone or other wireless audio device. The station 200 may include Bluetooth capability to effect wireless audio pairing. As shown, the top face 226 does not contained volume or other control buttons as in the prior embodiment other than the power or pairing button 240 of the docking station 200 to which an tablet or smartphone connects. With this configuration it is apparent that the functionality shown in FIG. 2B but not in 2C is moved to the tablet or smartphone.

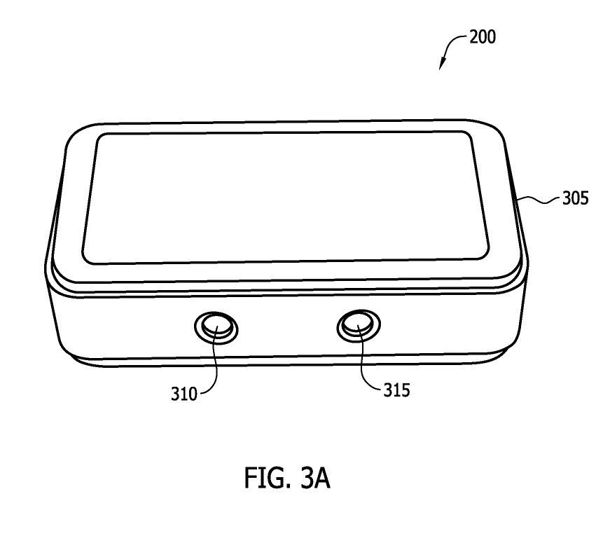

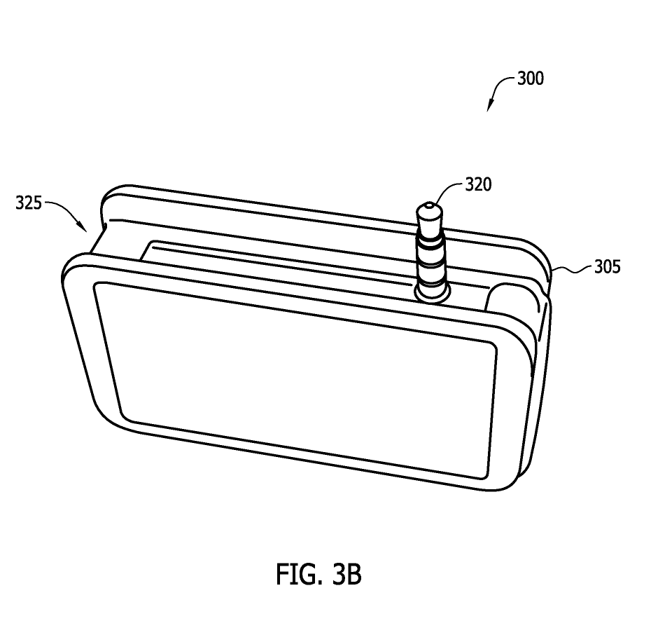

FIGS. 3A and 3B illustrate an alternative audio controller 300. The audio controller 300 includes a housing 305. The housing 305 may include a headphone jack 310 for connection with a listening device, such as the listening device 120. In another embodiment, the headphone case may not be present and the audio may be sent wirelessly to the wireless headphone. The housing 305 may also include one or more audio transducer ports 315. Each of the audio transducer ports 255, which may be 3.5 mm jacks, is associated with a channel and is coupled to the audio transducer interface 180 (not shown). A male connector 320 provides a connection between the mobile device interface 155 (not shown) of the audio controller 300 and the audio interface 130 (not shown) of the mobile device.

The housing 305 may also include a channel 325 that is sized to accommodate a mobile device, such as a smart phone. The channel 325 facilitates a physical coupling between the housing 305 and the mobile device.

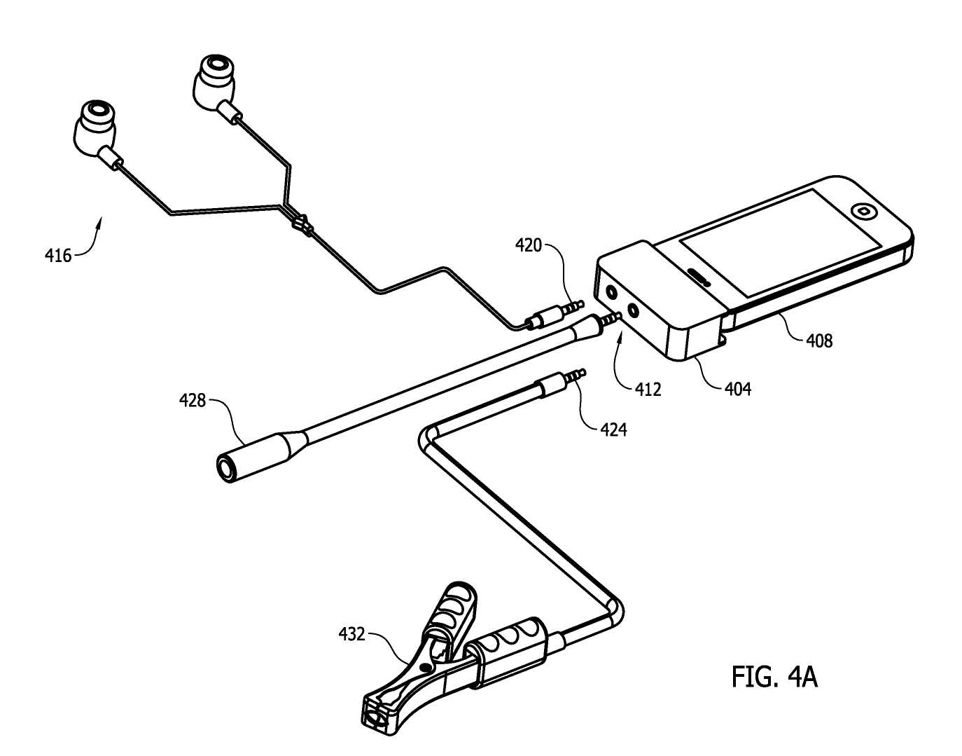

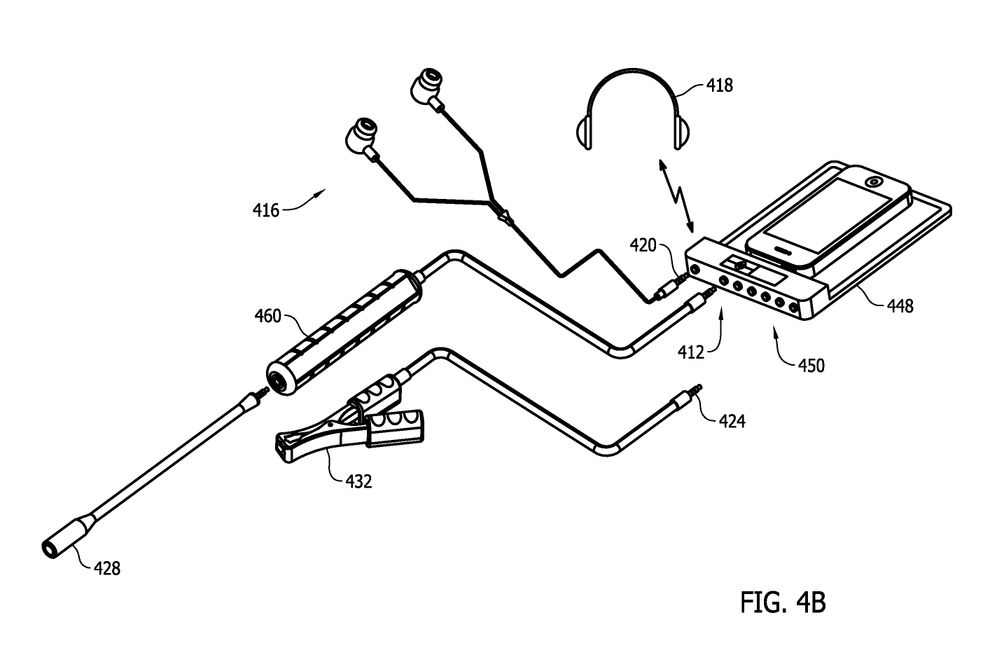

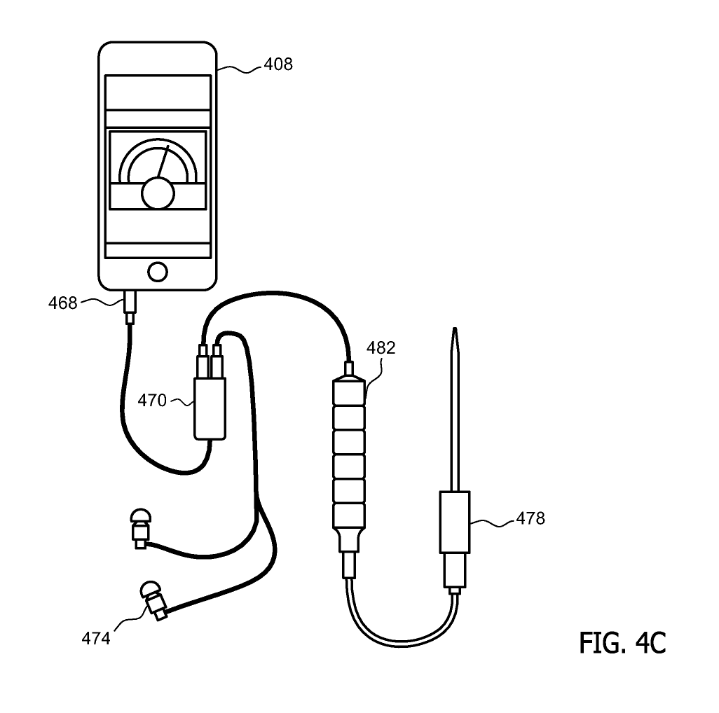

FIG. 4A illustrates exemplary audio transducers 400 for use with a first type audio controller. In FIG. 4A, an audio controller 404 connects to a mobile device 408 which in this embodiment is a smartphone but could also be a tablet. The audio controller may connect to the mobile device through the mobile device's audio port.

One or more input/output ports 412 are on the audio controller 404. One input/output port 412 is a headphone or speaker port to which headphones 416 could connect using a standard headphone plug 420. In other embodiments, a wireless link may be established between the audio controller 404 and headphones 416, such as a Bluetooth link and wireless headphones 418. Also connecting to the audio controller 404 are one or more sensors configured to detect vibration, sounds, or other input. The sensor may comprise a microphone, piezo detector, vibration sensor, or other element being monitored. These sensors may include a probe 428 which the user may point or physically touch to a location for monitoring, or a clamp 432 with a sensor associated with the clamp. The probe 428 may be placed in contact with an area of interest, and may be moved as the user listens to the audio in order to hear different areas. The probe 428 may be removably coupled to a handle (not shown) that also has a connection port, that includes wiring to pass through signals from the probe 428. The handle facilitates easier manipulation of the probe 428. The handle may not be necessary when the probe 428 is coupled directly to the audio controller 404.

A clamp 432 having a plug 424 may also be connected to a port 412. The clamp may connect to a location to be monitored, such as under a vehicle, and the cable connected to the clamp may be extended into the vehicle and plugged into the audio controller 404. The vehicle may then be driven while a user monitors for sound.

FIG. 4B illustrates exemplary audio transducers 400 for use with a second type audio controller. As compared to FIG. 4A, similar elements are labeled with identical reference numbers. Elements discussed in FIG. 4A are not discussed again in FIG. 4B. In this embodiment, the audio controller 448 is presented which has multiple channel input ports 450. It is contemplated that multiple sensors, such as clamp sensors 432 may connect using connector 424. Although only shown with one clamp, as many clamps may be connected as there are ports 50 to enable multi-channel operation. The audio controller 448 may be larger than the audio controller 404 of FIG. 4A and have one or more user input buttons or screens as discussed herein for the user to select a channel.

Alternatively, the user may use the mobile device to select or change a channel. Also shown in this embodiment is a handle 460 between the probe 428 and the connector 412. The user may hold onto the handle 460 when using the probe 428. If the probe 428 contacts a moving part and is pulled into the machine, the probe will quickly and easily disconnect at the handle port connection thereby preventing the user or other parts of the system from being pulled into the machine.

The embodiment of FIG. 4B may also be configured with a wireless headphone or to communicate with wireless headphones, such as for example using the Bluetooth communication format. Bluetooth headphone and pairing is well known in the art and as such it is not describe in detail herein. The controller 448 (being of any embodiment shown herein) may thus be configured with a wireless transceiver or transmitter for sending audio data or other types of data to the headphones or other destination.

FIG. 4C illustrates an exemplary light version of the audio detector paired directly to a mobile device through a splitter element. In this embodiment, a mobile device 408, such as a smartphone or tablet, which includes an audio port connector 468 configured to connect and disconnect to an audio port or headphone jack. The connector 468 electrically connects to a splitter 470, which splits the audio signal into two separate components. The splitter 470 may be configured with two or more audio (electrical) output ports, one of which may connect to speakers or headphones 474, or a separate wireless transmitter for generation and transmission of a wireless signal. The other output of the splitter is configured to connect to and configured to receive electrical input from a sensor 478 which represents audio or vibration sound. The sensor 478 may be any type sensor as described herein including a clamp, probe, microphone, or any other type audio sensor or pickup. Between the sensor 478 (probe) and the splitter 470 is a connector or handle 482 configured to connect to the splitter and also connect and disconnect to the sensor 478 which detector the audio or vibration, which is converted to an electrical signal. One or more batteries, if so required and configured, may be stored in the splitter, handle 482, or probe 478.

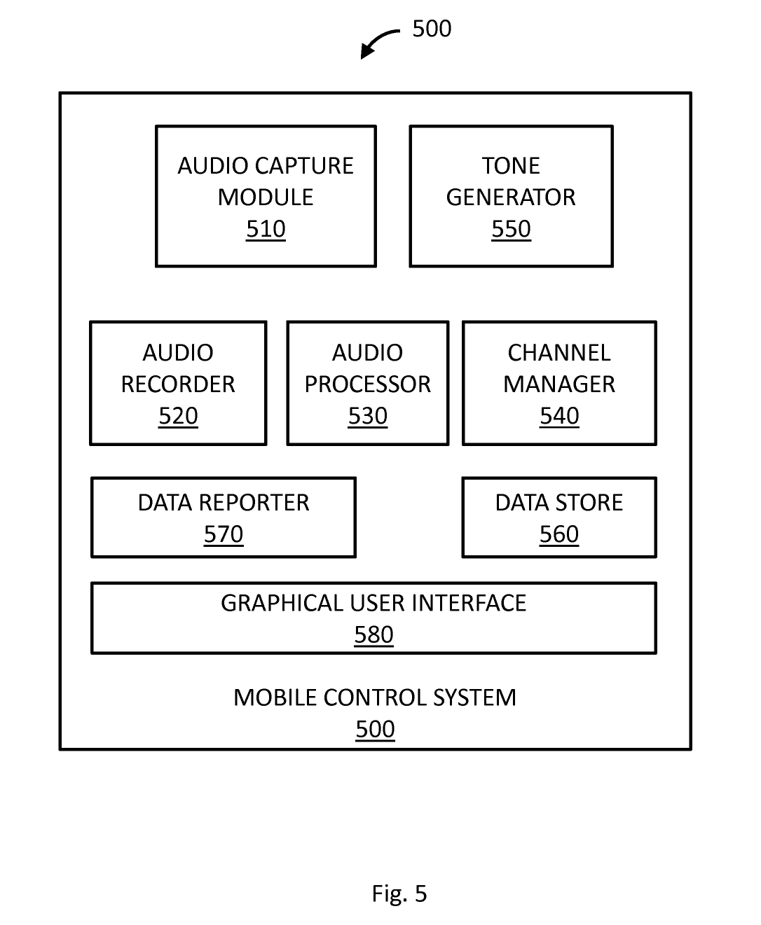

FIG. 5 is a block diagram of an exemplary mobile control system 500 for use with the system 100 of FIG. 1. The mobile control system 500 includes an audio capture module 510, an audio recorder 520, an audio processor 530, a channel manager 540, a tone generator 550, a data store 560, a data reporter 570, and a graphical user interface 580. The mobile control system 500 may be implemented as software and/or hardware on a mobile device, such as mobile device 110. For example, the mobile control system 500, including computer-readable instructions, may be stored in the memory 145, which may be non-transitory, and executed by the processor 150 (shown in FIG. 1). The graphical user interface (GUI) 580 is used to display information to the user and receive inputs using, for example, the display 135 and the human interface device 140 (also shown in FIG. 1). The data store 560 may be any database, file storage, and/or other data storage format or system now known or later developed.

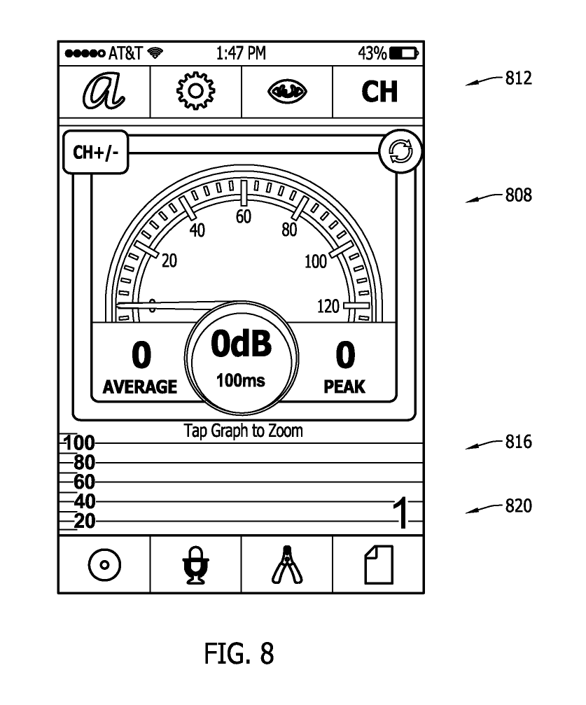

FIG. 8 illustrates an exemplary screen shot of the graphical user interface 580. The GUI 580 may include a decibel meter 808, which may include peak and/or average decibel readings. The GUI 580 may also display a waveform area 816 to display audio signals when in use, which may also include a visual representation of peaks and/or averages in amplitude. A channel indicator 820, in this figure channel 1, may also be shown. The GUI 580 may also include a visual representation of a vehicle and the user may identify the location of audio transducers, or channels, relative to the vehicle on the visual representation. A menu bar 812 may be presented in this exemplary screen shot to access other features and screen as are discussed below.

The graphical user interface 580 is configured to accept a channel selection from the user. The user may select a channel from a list, using up/down arrows, etc. The user may associate a label or name with each channel, and the name together with the associated channel may be stored in the data store 560. For example, the user may label channel 3 “front left axle” because it is associated therewith. The graphical user interface 580 is configured to transmit the channel selection to the channel manager 540, which may also be responsible for labeling the channels.

The channel manager 540 is configured to instruct the tone generator 550 to generate a tone, or signal, associated with the selected channel such that the audio controller 105 switches to the selected channel. The tone generator 550 is configured to generate tones corresponding to channels and transmit the generated tones to the audio controller 105 via the mobile device audio interface 130.

The audio capture module 510 is configured to receive audio from the audio controller 105, shown in FIG. 1. The audio received by the audio capture module 510 is generally the audio received by the audio transducers 115, and more particularly, the audio received by the audio transducer 115 associated with the selected channel. The audio recorder 520 may record the captured audio and store it in the data store 560. The audio recorder 520 may be configured to play back recorded audio using a listening device associated with the mobile device, such as a speaker or headphones. The listening device associated with the mobile device may be wirelessly connected to the mobile device, using, for example, Bluetooth.

The audio processor 530 is configured to process, analyze, filter, and/or otherwise manipulate the captured audio from the audio capture module 510. The audio processor 530 may operate on captured audio in real-time as it is received, and/or it may operate on audio recorded by the audio recorder 520. The audio processor 530 may process audio before it is played through the listening device connected to the mobile device and/or before a sound wave representative of the audio is displayed via the graphical user interface 580.

The audio processor 530 may transform the captured audio in any manner now known or later developed. The user may select a processing method and provide inputs or settings to the processing method using the graphical user interface 580. As an example, the audio processor 530 may perform a Fourier transform, including a Fast Fourier transform, on the captured audio to produce a frequency spectrum. The frequency spectrum may be displayed by the graphical user interface 580. As another example, the audio processor 530 may filter the captured audio by frequency, amplitude, or other audio characteristics.

The audio processor 530 may facilitate identifying the source of undesired noise by comparing audio from multiple channels. The audio processor 530 may compare recorded audio and/or audio captured in real-time. For example, the audio processor 530 may cause two or more sound wave representations to be shown via the graphical user interface 580. The user may identify, from the overlaid waves, which channel produces a unique waveform and/or which channel produces a waveform having the greatest amplitude, either of which may indicate the source of the undesired noise. Alternatively, or additionally, the audio processor 530 may compare the audio from two or more channels and identify the likely source of the undesired sound based on the amplitude, frequency, or other relative characteristics of the sound waves. The identified channel may be displayed using the graphical user interface 580.

The data reporter 570 is configured to transmit captured audio, whether stored in the data store 560 or otherwise, to a remote host (not shown) via a network (not shown), such as the Internet. The audio may be compressed, placed in an audio file container, transcoded, down-sampled, or otherwise processed before transmission. Information about the channel or channels associated with the captured audio, including channel names, may be transmitted with the captured audio.

Transmitting the captured audio to a remote host enables further processing and analysis of the captured audio. For example, the remote host may be associated with a mechanic, and the mechanic may play back the transmitted audio to facilitate diagnosis of the problem. In another example, the captured audio may be sent to an auto manufacturer or other party, which may maintain a database of known problem sounds. The remote host may compare the transmitted audio with audio in the database to determine if the audio is similar to audio associated with known problems. The transmitted audio may, for example, be similar to audio in the database associated with a loose tailpipe. Sound waves, or representations of sound waves including hashes, may be used to compare the transmitted audio with the audio in the database. The channel name associated with the transmitted audio may also be used to match against words or phrases associated with known problems in the database. The make and model of a vehicle may also be transmitted with the captured audio and may be used in the diagnosis, whether the diagnosis is performed by a human or the remote host.

The data reporter 570 is configured to receive a report back from the remote host. The report may include a possible diagnosis, from either a person or a problem sound database. The contents of the report may be displayed using the graphical user interface 580.

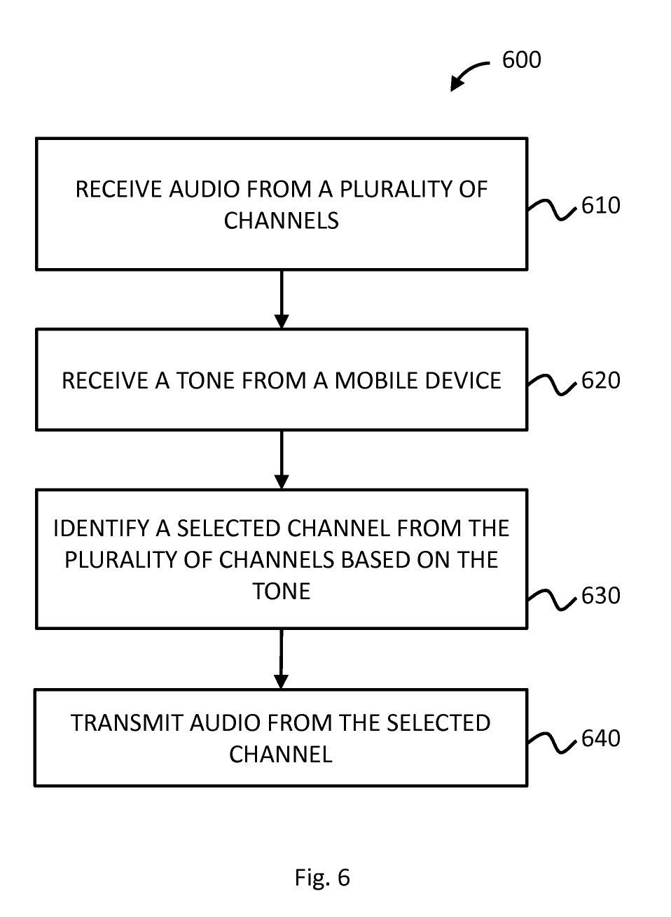

FIG. 6 is a flowchart of an exemplary method 600 for use with the system 100 of FIG. 1. In step 610, an audio controller 105 (such as a smartphone or tablet), receives audio from one or more channels. More particularly, the audio controller receives audio from one or more audio transducers, e.g., audio transducers 115. After listening to a channel, at a step 610, the user may advance to step 614 and elect to listen to a different channel as part of the noise detection operation. To make this change, the user, at a step 616, presses or actuates a button on the audio controller or selects a different channel using a graphical interface on the software presented on the mobile device. For example, if the mobile device has a touch screen, the user may touch a displayed button or tab to select a different channel. The following discussion focuses on the embodiment of the user interfacing with a mobile device to have changed the channel.

At a step 620, the mobile device, after receiving the input from the user to change channel generates a tone and sends the tone outward through the audio port of the mobile device to the audio controller. In one embodiment, the tone or command may be sent through the data port, of the mobile device data port if the mobile device audio port is used to communicate with the audio controller. It is contemplated that a unique tone is associated with each channel. In other embodiment, a single tone is used to indicate a change in channel, such that each time the single tone is used the channel will increment or decrement. It would also be possible to send a code, or DTMF, or any other combination of signals which could be detected and decoded at the audio controller.

At a step 622, the audio controller receives the tone from the mobile device. It may be received through the electrical or wireless connection over which the audio controller communicates with the mobile device. At a step 630, the audio controller processes the one or more tones with an internal tone detector's other element to determine and identify the selected channel. If the user were to press a button on the audio controller to select a different channel (instead of using the mobile device software interface), pressing the button would cause the audio controller to select a different channel.

At a step 634 the audio controller performs a switching operation to connect another and different channel's signal (from transducer/microphone/vibration detector) to the output of the audio controller to thereby provide this different channel's audio signal to the mobile device. This may occur with a physical or integrated circuit switch operation. As discussed above, while the audio controller may have numerous channels from the transducers, it may have a few numbers, such as one, of audio outputs to the mobile device. As a result, an internal controlled switching operation within the audio controller selectively connects an input to the output based on user selections.

In step 640, the audio controller transmits audio from the selected channel to the mobile device and/or a listening device such as headphones. Thus, the audio controller changes input channel based at least in part on a tone received from a mobile device.

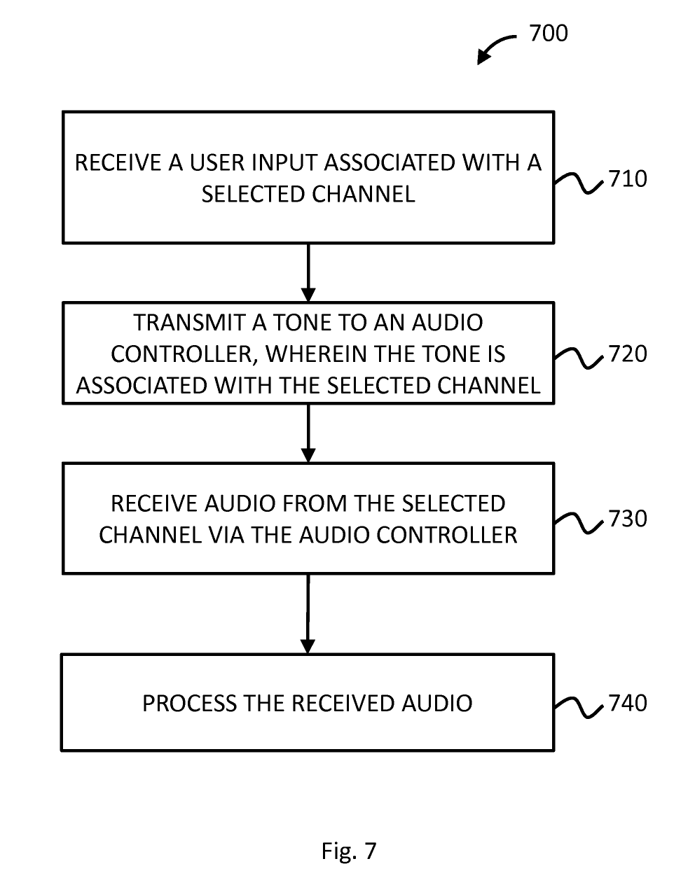

FIG. 7 is a flowchart of an exemplary method for use with the system 100 of FIG. 1. In step 710, a mobile device, such as the mobile device 110, receives a user input associated with a selected channel. The user input may be received through a graphical user interface, such as the graphical user interface 580, shown in FIG. 5. In step 720, the mobile device generates and transmits a tone to an audio controller, such as the audio controller 105 shown in FIG. 1. The tone is associated with the selected channel. The tone may be pre-recorded or generated.

In response to the tone, the audio controller switches input channels to the selected channel. In step 730, the mobile device receives audio from the selected channel via the audio controller. In step 740, the mobile device processes the received audio. More particularly, the mobile device captures and records and/or performs audio processing on the received audio, as described herein. Thus, the mobile device is capable of changing the channel on the audio controller using a tone generated by the mobile device.

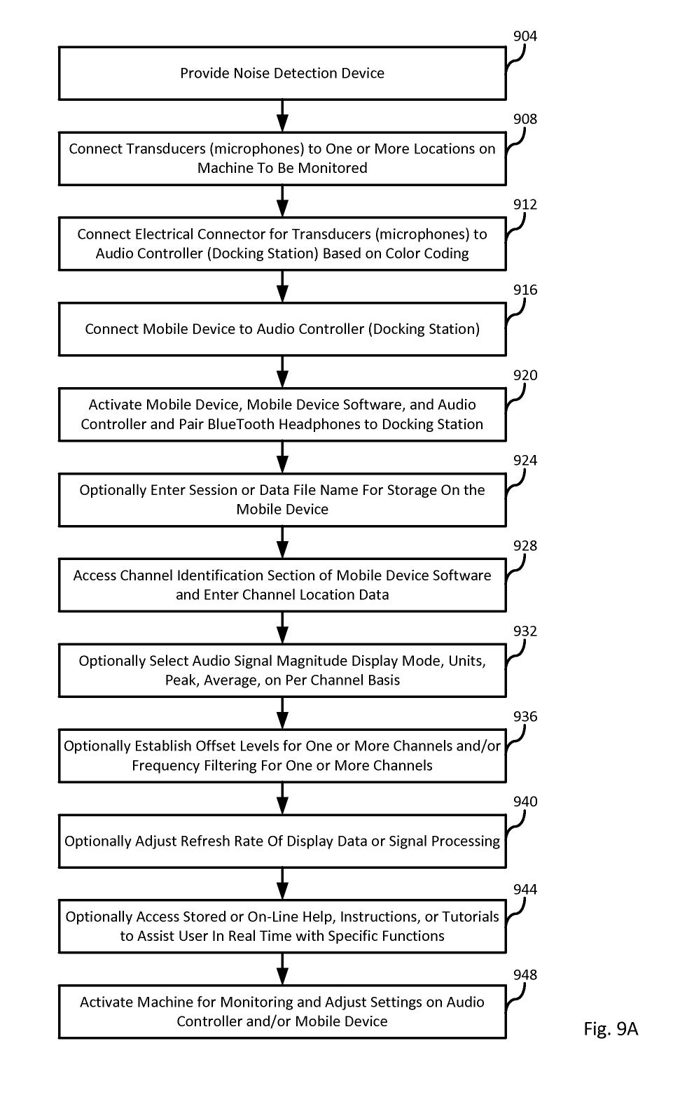

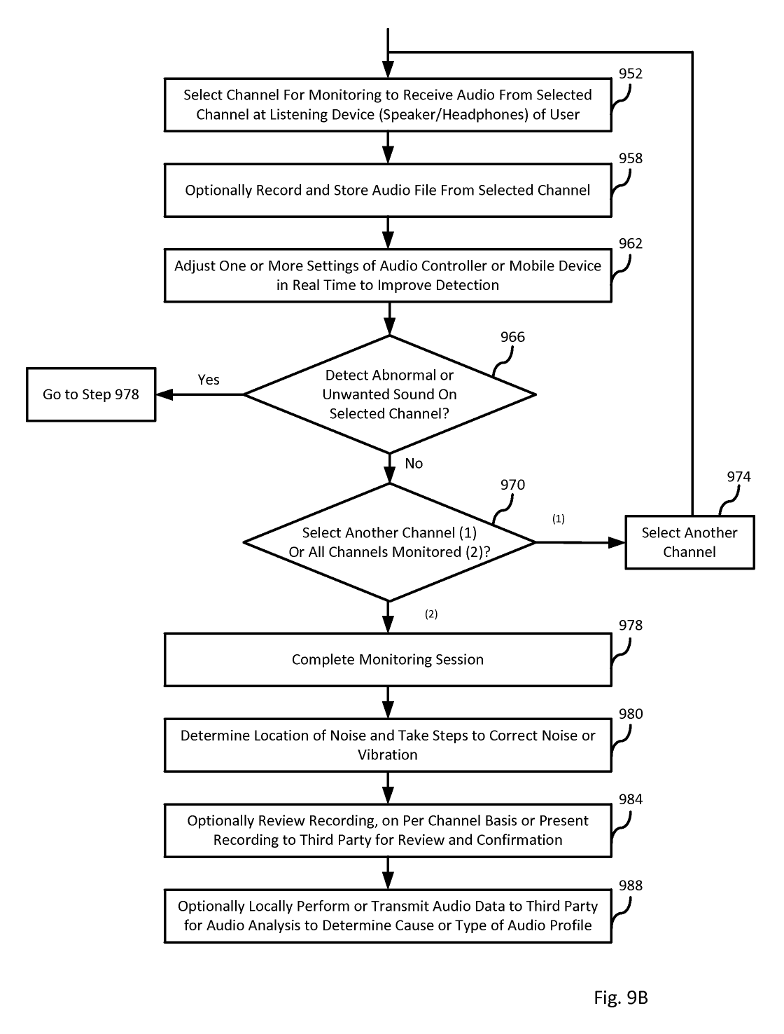

FIGS. 9A and 9B illustrate an exemplary flow diagram of an example method of operation. This is but one possible method of operation and use. In other embodiments or in other applications, different methods of use may be utilized. It is contemplated that this method of operation may be utilized with any of an audio controller that is a single channel unit or a multiple channel unit, or with a smartphone or table device. The method of operation may be performed with any number of channels.

At a step 904, the noise detection system is provided. The noise detection system comprises one or more of a transducer, audio controller, and a processing device, such as a smartphone or tablet. The processing device may be provided as part of the system or provided by a user of a system. At a step 908, the user connects transducers, such as microphones or piezo vibration sensors, to the machine or other element being monitored. Connection may occur through clamping, taping, magnets, wraps, or by the user manually pointing or touching the transducer to the area to be monitored.

At a step 912, the user electrically connects the transducers to the audio controller. This may occur by plugging a connector into one or more ports on the audio controller. There may be multiple connectors and ports or a single connector and port. At a step 916 the user connects the mobile processing device to the audio controller. The audio controller may be considered a docking station to which the mobile processing connects. In one embodiment, the connection is through an audio port of the mobile device. In one embodiment, the connection is through a data port of the mobile device.

At a step 920, the user activates the mobile device, mobile device software, and the audio controller, and also pairs the Bluetooth headphones with the docking station. Bluetooth, or other types of wireless pairing, is known in the art and thus not described in detail. This may occur in any specific to the devices and software. The software is considered to be machine executable code capable of being stored in memory and executed by a processor. At a step 924, the user may optionally enter a session name or file name to store the monitoring. To do this the user may be presented with a file name entry screen or provide an option to save the session.

At a step 928, the user may optionally access the channel identification section of the mobile device software and enter channel location data. This may occur by the software presenting data entry fields for each channel into which a user may type text or numbers. For example, the user may enter the term front wheel well for channel 1 to designate the channel 1 transducer is connected to this location. This data may be stored for a final report or to aid analysis.

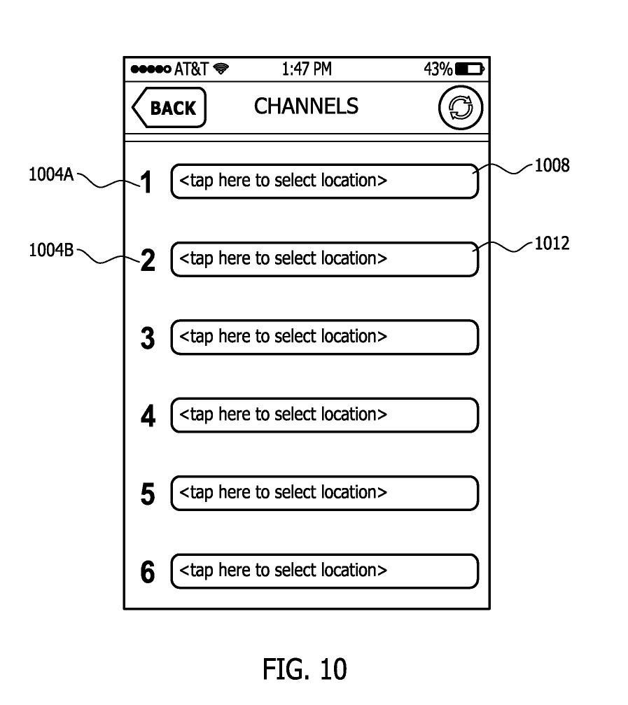

FIG. 10 is an exemplary screen shot of a channel identification screen presented by the software. As shown, channel identifiers 1004A, 1004B are shown with associated text entry fields 1008, 1012. By tapping on or otherwise selecting a text entry field 1008, 1012 a user may enter a location (such as fender, or shock absorber) at which the transducer is located.

At a step 932, the user may optionally set signal magnitude display mode, units, peak signal values, average signal values for the display for one or more channels. For example, the user may establish the software to display the detected signal in various ways, such as peak magnitude or average magnitude. The units in which the data is displayed are also adjustable by the user.

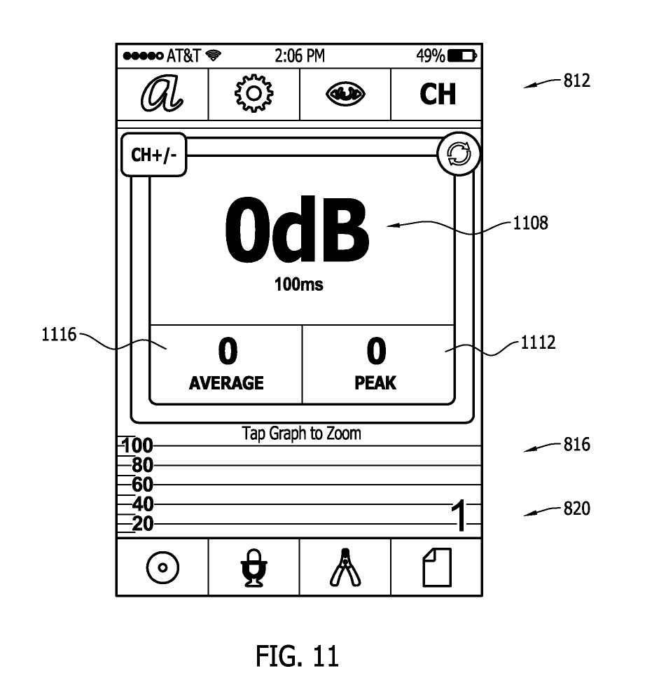

FIG. 11 and FIG. 8 are an example screen displays presented by the software for displaying information regarding the audio signal to the user. FIG. 8 and the elements shown in FIG. 8 are discussed above. FIG. 11 illustrate the text field 1108 configured to display the audio signal's amplitude in dB units. Also shown are text fields for the peak signal magnitude 1112 and the average signal magnitude 1116.

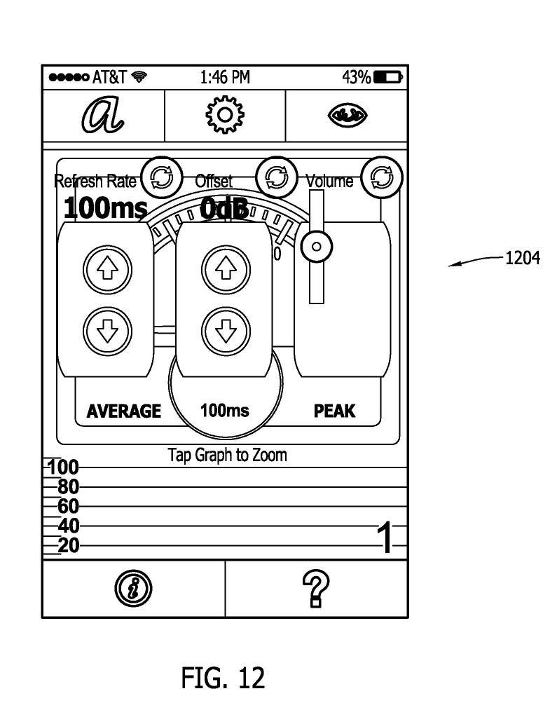

At a step 936 the user may optionally set one or more offset levels for the one or more channels and one or more frequency based filtering levels for the one or more channels. An offset level is a minimum threshold that the audio signal may exceed before the incoming audio signal is presented to the user. This is used to reduce or eliminate background noise. Frequency equalization, although new in this environment of use, is known to those familiar in audio system and as such is not shown in detail herein. FIG. 12 is an example screen display for controlling offset and refresh rate. In FIG. 12, the center area 1204 of the screen shows, from left to right, the refresh rate control, the offset value control, and the volume control.

At a step 940 the user may optionally set or adjust a refresh rate for the display of data or the acceptance of data or the signal processing of the data. This will control how often the display is updated or how many samples per second are presented to the user or recorded. At a step 944, the user may access online or stored help files, instructions, or tutorial to assist the user, in real time, with the specific functions and operation of the device.

At a step 948, the user activates the machine and initiates the monitoring process. As part of this, at a step 952, the user selects a channel for monitoring. This selected channel is then the channel for which audio is routed through to the user, such as to the mobile device and then the audio player, such as a speaker or headphones. FIGS. 6 and 7 define the process of changing channels in greater detail. At a step 958, the user may optionally elect to record and record the audio files from the selected channel. This provides a permanent record of the audio from the channel which can be used for presentation to others that the audio event was occurring and after repair or adjustment, the audio event is no longer occurring. The audio file may also be stored for later analysis or transmission to a remote location, such as by email, text, or file upload.

At a step 962, the user may adjust one or more settings of the software or hardware in real time to improve detection. For example, the user may adjust any of the setting described above to improve detection. At a decision step 966 the user determines whether they have detected abnormal or unwanted sounds as a result of the monitoring at steps 952 and 962. If the abnormal or unwanted sound is identified, then the operation may advance to step 978. If the abnormal or unwanted sound is identified is not yet identified then the operation advances to decision step 970.

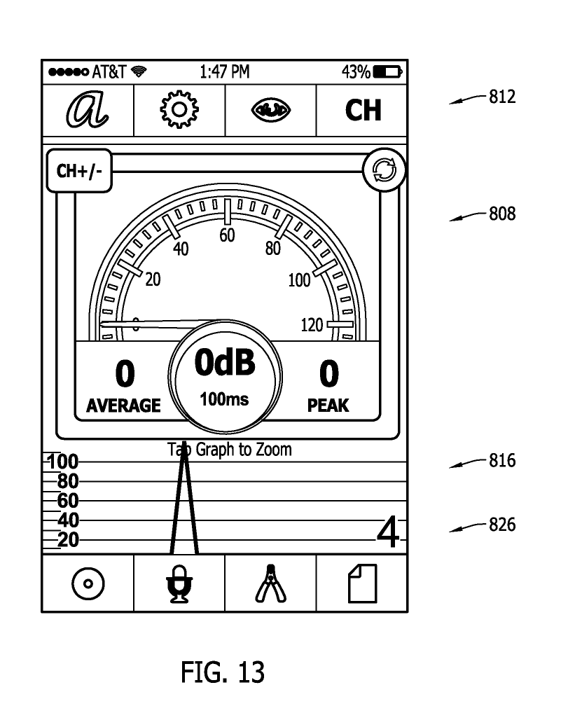

At decision step 970 the user may select another channel for monitoring such as by listening. This may occur by the user tapping or otherwise selecting a function of mobile device that selects the next channel or another user selected channel. This may occur at step 974 if the user has not yet monitored all channels. FIG. 13 illustrates an exemplary screen shot of a tone 1304 shown in area 816 generated by the mobile device to cause the audio controller to change the channel. This tone is presented to the audio controller to cause the audio controller to change the channel presented to the mobile device. FIG. 13 is generally similar to FIG. 8 with common elements being labeled with identical reference numbers. From step 974, the operation returns to the step 952 for additional monitoring.

In one embodiment, the software executing on the mobile device may have an auto monitor mode whereby the software automatically selects between each channel to monitor each channel for unwanted noise, such as noise over a threshold or noise that is higher than allowable for a particular connection point on the machine. By automatically monitoring for sounds, including the intensity and frequency, the system may be better and to detect and diagnose the sound than a human listener, which may have unknown hearing capability.

If all of the channels have been monitored in decision step 970, then the operation advances to step 978. At step 978, the monitoring session is complete and the operation advances to step 980. At step 980, the user may determine the location of the noise or vibrations, based on the monitoring, and take steps to correct the unwanted or abnormal noise or vibration. At a step 984, the user may optionally review any audio recording made during the session. The audio recording may be presented along with a visual display of the channel, intensity, and frequency profile. It is also contemplated that the user may present this recording to third parties, such as a before and after fixing profile.

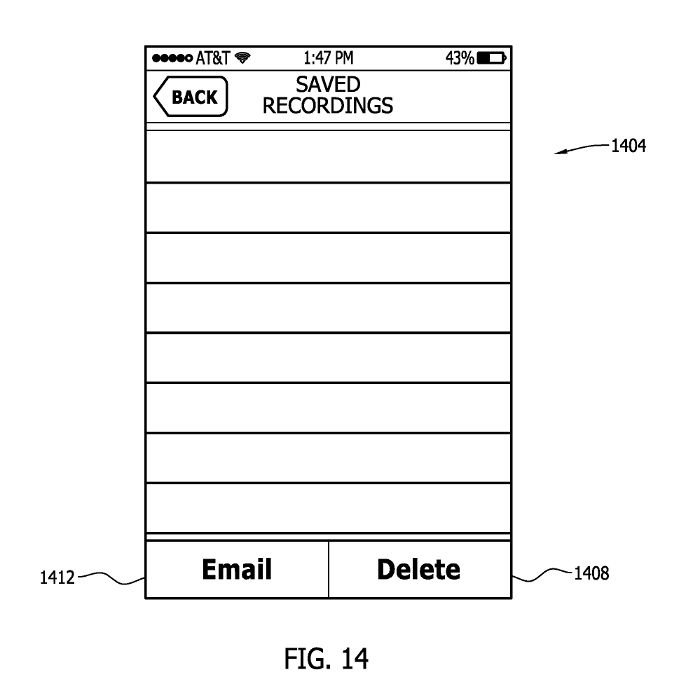

In addition, at a step 988 the audio file, with all associated data, such as channel, channel location, frequency profile, machine type, weather, date, may be stored and transmitted to a third party for analysis or stored on the mobile device and analyzed. FIG. 14 illustrates an example screen display showing file listings with an option to e-mail audio file. In this figure, a list of audio recordings (with associated data, such as channel, date, time, offset, frequency equalization, etc.) is presented in list section 1404. Also provided for the user is a delete file option 1408 and an e-mail file option 1412. The email file option allows the user to send the file to a remote location or other person. The user may also upload or otherwise transmit the file.

The analysis may be comparison to a database of other similar or normal sounds to determine more information about the sounds or vibrations based on comparison of this sound profile to from other similar situation. By using complex analysis against a large database of other sounds, diagnostics may be improved. It is contemplated that the sound may be uploaded or e-mailed to a remote location.

The logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

It will be appreciated that the above embodiments that have been described in particular detail are merely example or possible embodiments, and that there are many other combinations, additions, or alternatives that may be included.

Also, the particular naming of the components (including, among other things, engines, layers, and applications), capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component.

Some portions of the above description present features in terms of algorithms and symbolic representations of operations on information. These algorithmic descriptions and representations may be used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “identifying” or “displaying” or “providing” or the like, refer to the action and processes of a computer system, or similar electronic computing device, that manipulates and transforms data represented as physical (electronic) quantities within the computer system memories or registers or other such information storage, transmission or display devices.

Based on the foregoing specification, the above-discussed embodiments of the invention may be implemented using computer programming or engineering techniques including computer software, firmware, hardware or any combination or subset thereof. Any such resulting program, having computer-readable and/or computer-executable instructions, may be embodied or provided within one or more computer-readable media, thereby making a computer program product, i.e., an article of manufacture, according to the discussed embodiments of the invention. The computer readable media may be, for instance, a fixed (hard) drive, diskette, optical disk, magnetic tape, semiconductor memory such as read-only memory (ROM) or flash memory, etc., or any transmitting/receiving medium such as the Internet or other communication network or link. The article of manufacture containing the computer code may be made and/or used by executing the instructions directly from one medium, by copying the code from one medium to another medium, or by transmitting the code over a network. One or more processors may be programmed or configured to execute any of the computer-executable instructions described herein.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed:

1. An audio controller comprising:
an audio transducer interface that is capable of receiving multi-channel audio from one or more audio transducers, each of the audio transducers associated with a channel;
a channel selector configured to receive the multi-channel audio from the audio transducer interface;
a tone detector configured to receive a tone from a mobile device such that the tone is associated with a selected channel, the tone detector configured to cause the channel selector to output audio associated with the selected channel; and
a listening device interface configured to transmit the audio output from the channel selector to a listening device.

2. An audio controller in accordance with claim 1, further comprising a processor configured to receive an indication of the selected channel from the tone detector and to cause the channel selector to output audio associated with the selected channel.

3. An audio controller in accordance with claim 1, further comprising a wireless interface configured to wirelessly transmit the audio output.

4. An audio controller in accordance with claim 1, further comprising a mobile device interface configured to transmit the audio output from the channel selector to the mobile device.

5. An audio controller in accordance with claim 1, further comprising a pre-amplifier configured to amplify the multi-channel audio from the audio transducer interface and to output the amplified multi-channel audio to the channel selector.

6. A system comprising:
two or more audio transducers configured to generate two or more audio signals; and
an audio controller remote from the two or more audio transducers, the audio controller having an audio output port and two or more audio input ports comprising:
an audio transducer interface that is capable of receiving audio signals on the two or more audio input ports from two or more audio transducers, each of the two or more audio transducers associated with a channel;
a tone detector, the tone detector configured to electrically connect to and receive a tone from a mobile device, the tone indicating a change in the channel that changes which of the two or more audio signals is the selected audio signal, the tone detector configured to generate a channel change signal;
a channel selector coupled to the audio transducer interface, the channel selector configured to receive the channel change signal and in response, change which of the two or more audio signals is the selected audio signal, the selected audio signal being sent to the audio output port; and
a listening device interface configured to transmit the selected audio signal from the audio output port to a listening device.

7. A system in accordance with claim 6, wherein the audio controller further comprises a mobile device interface configured to transmit the audio output from the channel selector to the mobile device.

8. A system in accordance with claim 7, wherein the tone is received from the mobile device over the mobile device interface based on user input to a touch screen which generates the tone.

9. A system in accordance with claim 6, further comprising a mobile device, the mobile device including a memory storing non-transient machine readable code configured as an audio recorder configured to record audio from the selected channel received from the audio controller.

10. A system in accordance with claim 9, wherein the mobile device further comprises an audio processor configured to process audio received from the audio controller, wherein processing audio comprises at least one of equalization, offset, and audio signal comparing to an audio signal library.

11. A system in accordance with claim 9, wherein the mobile device includes a memory storing non-transient machine readable code configured to transmit recorded audio to a remote location.

12. A system in accordance with claim 11, wherein non-transient machine readable code configured to transmit recorded audio is further configured to receive and display a diagnosis from the remote location.

13. A method for changing channels in a vibration detection system configured to receive audio signals caused by vibration using an audio controller, the method comprising:
receiving two or more audio signals on two or more channels from two or more vibration detectors, of which one audio channel is a selected channel and one audio signal is a selected audio signal;
receiving a tone from a mobile device, the tone identifying the selected channel or indicating a channel change request to change the selected channel;
identifying the selected channel from the two or more channels based on the tone;
responsive to the identifying, performing a switching operation to generate as an output signal the selected audio signal;
transmitting the output signal a user.

14. The method of claim 13, wherein transmitting the output signal to a user comprises transmitting the selected output signal to the mobile device, to an audio interface for receipt by a user, or to both the mobile device and the audio interface.

15. The method of claim 13 wherein transmitting the output signal to a user comprises transmitting the output signal over a wireless link to a remote speaker.

16. A method for changing channels on an audio controller, the method comprising:
receiving audio signals from two or more channels, the audio signals received from transducers connected to two or more locations of a machine;
receiving a user input at the audio controller to change and establish a selected channel;
performing a switching operation within the audio controller to electrically connect the selected channel to an output of the audio controller;
transmitting the audio signal from the selected channel to the user;
sending the audio signal from the selected channel to a mobile device, the mobile device configured to visually display one or more aspects of the audio signal.

17. A method in accordance with claim 16, wherein sending the audio signal further comprises sending the audio signal to a user either through a wireless link.

18. A method in accordance with claim 16, further comprising storing the received audio in the mobile device to create a stored audio file.

19. A method in accordance with claim 16, wherein sending the audio signal from the selected channel to a mobile device includes sending the audio signal to an audio input port of the mobile device.

20. A method in accordance with claim 16, further comprising performing frequency equalization or magnitude offset to the audio signal.

21. A method in accordance with claim 18, further comprising sending the stored audio file to a remote location over a computer network.

22. A system for detecting noise or vibration for use with a mobile device, the system comprising:
two or more transducers configured to generate two or more electrical signals representing noise or vibration received by the two or more; and
a controller remote from the two or more audio transducers, the controller including:
two or more input ports configured to receive the two or more electrical signal from the transducers, each of the two or more transducers associated with a channel;
a channel selector, configured to electrically connect to and receive instructions from a mobile device to control which of the two or more electrical signals is a selected signal that is provided to the mobile device for processing by the mobile device,
one or more output ports configured to:
provide at least one selected signal representing a noise or vibration to the mobile device for processing by the mobile device;
present the instructions from mobile device to the channel selector;
a listening device interface configured to provide the selected signal to a listening device.

23. The system of claim 22, wherein at least one selected signal representing audio provided to the mobile device is in a digital format and the mobile device comprises a tablet computer or a smartphone.
